(19) United States
(12) Patent Application Publication
(10) Pub. No.: US 2014/0176428 A1
(43) Pub. Date: Jun. 26, 2014

(54) FLEXIBLE ELECTRONIC DEVICE AND METHOD FOR CONTROLLING FLEXIBLE ELECTRONIC DEVICE

(71) Applicant: FIH (Hong Kong) Limited, Kowloon (HK)

(72) Inventor: HSING-CHUN HSIEH, New Taipei (TW)

(73) Assignee: FIH (HONG KONG) LIMITED, Kowloon (HK)

(21) Appl. No.: 14/135,602

(22) Filed: Dec. 20, 2013

(30) Foreign Application Priority Data
Dec. 24, 2012 (TW) 101149651

(51) Int. Cl. G06F 3/03; G06F 1/16

(52) U.S. Cl. CPC G06F 3/03; G06F 1/1652
USPC 345/156

(57) ABSTRACT

In a method for controlling a data page displayed on a flexible display of a flexible electronic device, a plurality of gravity sensors located at each side of the flexible electronic device detects current position data of corresponding sides of the flexible electronic device. A curved angle and a curved direction of each side of the flexible electronic device is calculated based on the current position and a preset position of each side. An operation on the flexible electronic device is determined according to the curved angle and the curved direction of each side of the flexible electronic device. An instruction associated with each operation is executed to control movement of the data page displayed on the flexible display.

### CROSS-REFERENCE TO RELATED APPLICATIONS

This application claims all benefits accruing under 35 U.S.C. §119 from Taiwan Patent Application No. 101149651, filed on Dec. 24, 2012 in the Taiwan Intellectual Property Office, the content of which is hereby incorporated by reference. This application is related to commonly-assigned applications entitled, “FLEXIBLE ELECTRONIC DEVICE AND METHOD FOR CONTROLLING FLEXIBLE ELECTRONIC DEVICE”, Atty. Docket No. US47350.

### BACKGROUND

1. Technical Field

Embodiments of the present disclosure generally relate to electronic devices, and particularly to a flexible electronic device and a method for controlling the flexible electronic device.

2. Description of Related Art

Flexible display devices may be used in electronic devices. When a flexible display device of an electronic device is bent, data (such as images or text) can be normally displayed on the flexible display device. However, at present, touch gestures used for controlling normal touch panels are used for controlling the flexible display device.

Therefore, there is room for improvement in the art.

### BRIEF DESCRIPTION OF THE DRAWINGS

FIG. 1 is a block diagram of one embodiment of a flexible electronic device including a control unit.

FIG. 2 is one embodiment illustrating gravity sensors in the flexible electronic device of FIG. 1.

FIG. 3 is a block diagram of one embodiment of function modules of the control unit in FIG. 1.

FIG. 4 illustrates one embodiment of a coordinate system in relation to the gravity sensors of FIG. 2.

FIG. 5-FIG. 12 are embodiments illustrating a process of controlling the flexible electronic device in FIG. 1.

FIG. 13 is a flowchart of one embodiment of a method for controlling the flexible electronic device in FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

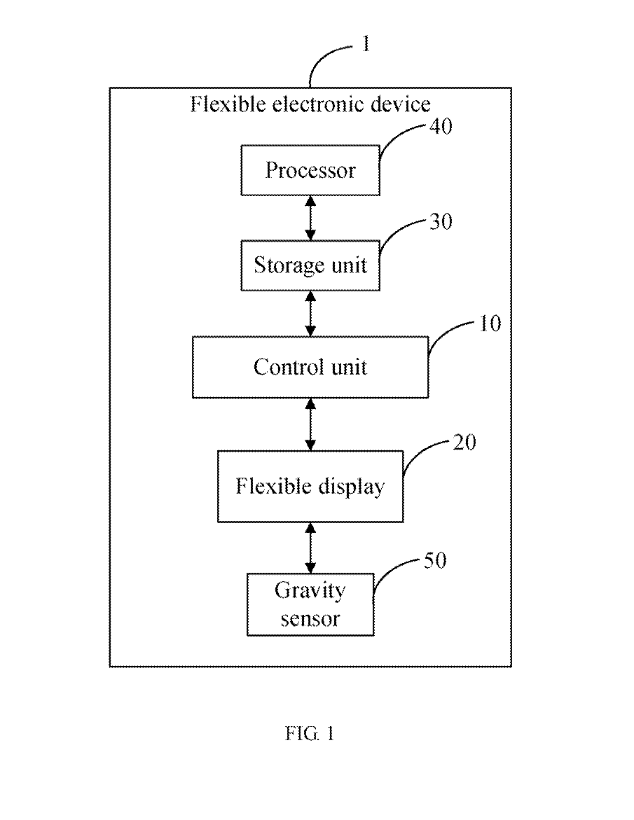

FIG. 1 is a block diagram of one embodiment of a flexible electronic device 1. In the embodiment, the flexible electronic device 1 includes a control unit 10, a flexible display 20, a storage unit 30, a processor 40, and a plurality of gravity sensors 50 (only one is shown in FIG. 1). In one embodiment, the flexible electronic device 1 is a mobile phone, but the disclosure is not limited thereto.

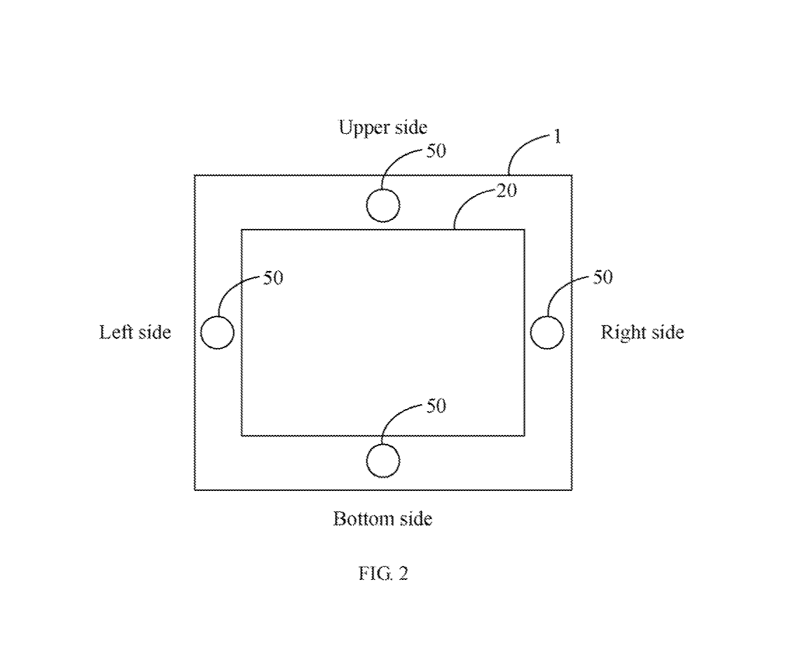

In one embodiment, as shown in FIG. 2, the flexible electronic device 1 includes four gravity sensors 50. One corresponding gravity sensor is located at each of an upper side, a bottom side, a left side, and a right side of the flexible electronic device 1 around the flexible display 20. When a user bends one or more sides of the flexible electronic device 1, the gravity sensors 50 detect current position data of the corresponding sides of the flexible electronic device 1, and send the corresponding current position data to the control unit 10. The control unit 10 controls a data page (e.g., an image or a Web page) displayed on the flexible display 20 according to the current position data of the corresponding sides of the flexible electronic device 1.

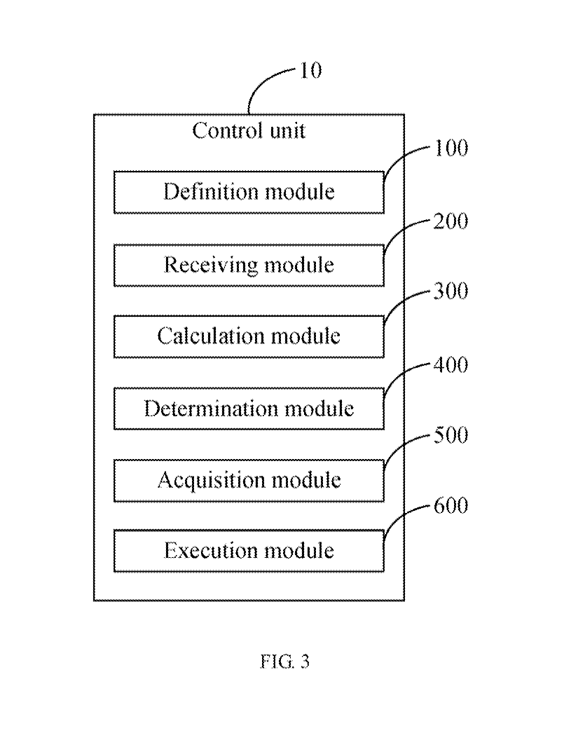

In one embodiment, the control unit 10 may include one or more function modules (as shown in FIG. 3). The one or more function modules may include computerized code in the form of one or more programs that are stored in the storage unit 30, and executed by the processor 40 to provide the aforementioned functions of the control unit 10. The storage unit 30 may be a dedicated memory, such as an EPROM or a flash memory.

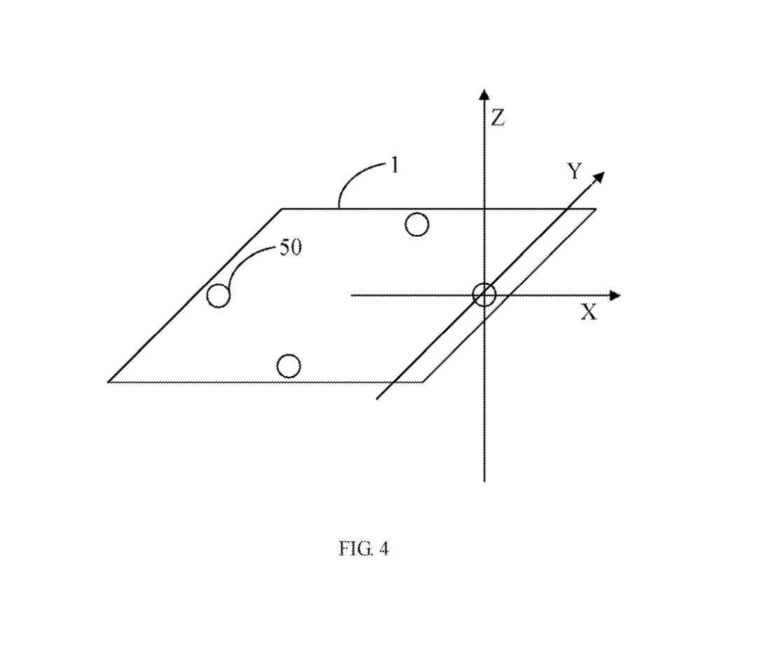

FIG. 3 is a block diagram of one embodiment of function modules of the control unit 10. In one embodiment, the control unit 10 includes a definition module 100, a receiving module 200, a calculation module 300, a determination module 400, an acquisition module 500, and an execution module 600. Descriptions of functions of the modules 100-600 is given with reference to FIG. 4-FIG. 13.

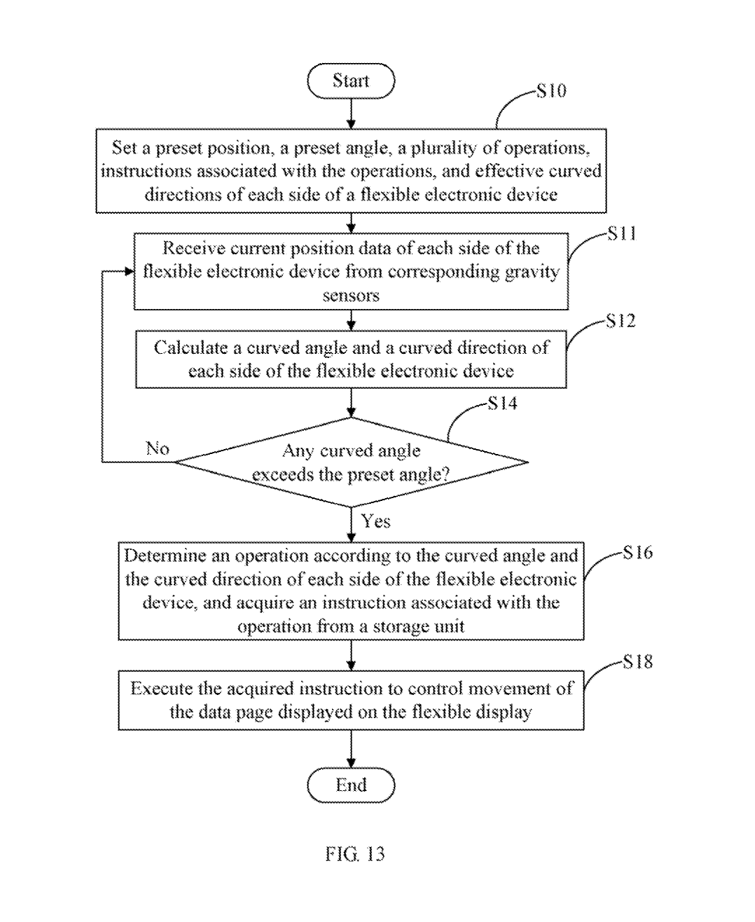

FIG. 13 is a flowchart of one embodiment of a method for controlling a data page displayed on the flexible display 20 of the flexible electronic device 1. Depending on the embodiment, additional steps may be added, others removed, and the ordering of the steps may be changed.

In step S10, the definition module 100 sets a preset position of each side of the flexible electronic device 1, a preset angle of bending a side of the flexible electronic device 1, a plurality of operations on the flexible electronic device 1 for controlling a data page displayed on the flexible display 20 of the flexible electronic device 1, instructions associated with the operations, and effective curved directions of each side of the flexible electronic device 1. In one embodiment, the preset positions, the preset angles, the operations, the instructions, and the effective curved directions are stored in the storage unit 30. In one embodiment, the preset position is set according to an XYZ coordinate system (shown in FIG. 4), and the preset angle is set as five degrees. The preset position of the flexible electronic device 1 is in the XY plane, such that the Z-axis is perpendicular to a front surface of the flexible electronic device 1.

In one embodiment, the operations are bending one or more sides of the flexible electronic device 1, and the instructions associated with the operations are moving, zooming in, or zooming out the data page. For example, if the operation is bending the left side of the flexible electronic device 1 upward, the associated instruction is controlling the data page to move right. If the operation is bending the upper side and the bottom side of the flexible electronic device 1 downward, the associated instruction is zooming in the data page.

In one embodiment, an effective curved direction of a side of the flexible electronic device 1 is defined as a curved direction having a corresponding instruction to control the data page displayed on the flexible display 20. For example, if bending the left side of the flexible electronic device 1 downwards does not correspond to an instruction, then bending the left side downwards is not an effective curved direction of the left side of the flexible electronic device 1. If bending both the left side and the right side of the flexible electronic device 1 downwards corresponds to an instruction, then bending both the left side and the right side downwards is an effective curved direction of the left side and the right side of the flexible electronic device 1.

In step S11, the receiving module 200 receives current position data of each side of the flexible electronic device 1 from the corresponding gravity sensors 50. In the embodiment, the current position data of each side of the flexible electronic device 1 is equal to a current position data of the corresponding gravity sensor 50. The current position data of the gravity sensor 50 is represented by the XYZ coordinate system.

In step S12, the calculation module 300 calculates a curved angle and a curved direction of each side of the flexible electronic device 1. In one embodiment, an angle between the preset position of a side of the flexible electronic device 1 and a current position of the side is regarded as the curved angle of the side of the flexible electronic device 1. A direction from the preset position of the side of the flexible electronic device 1 to the current position of the side of the flexible electronic device 1 is regarded as the curved direction.

In step S14, the determination module 400 determines whether any curved angle of the effective curved direction of the corresponding side of the flexible electronic device 1 exceeds the preset angle. If the curved angle of the effective curved direction of any side of the flexible electronic device 1 exceeds the preset angle, step S16 is implemented. If the curved angle of the effective curved direction of any side of the flexible electronic device 1 does not exceed the preset angle, the procedure returns to step S11.

In step S16, the acquisition module 500 determines an operation according to the curved angle and the curved direction of each side of the flexible electronic device 1, and acquires an instruction associated with the operation from the storage unit 30.

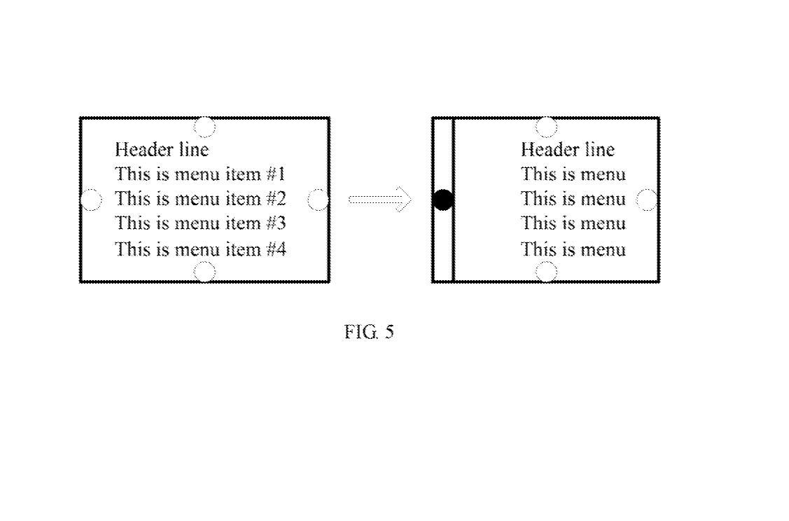

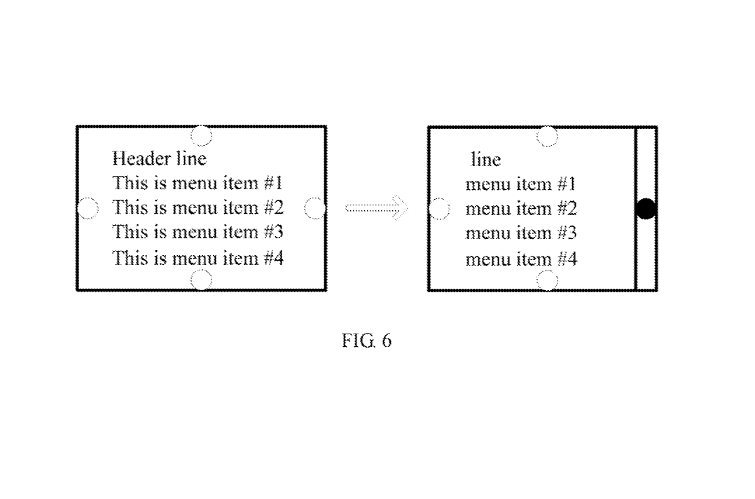

For example, as shown in FIG. 5, if the left side of the flexible electronic device 1 is bent upwards, and the curved angle of the left side of the flexible electronic device 1 exceeds the preset angle, an instruction for controlling the data page displayed on the flexible display 20 to scroll to the right is acquired from the storage unit 30. As shown in FIG. 6, if the right side of the flexible electronic device 1 is bent upwards, and the curved angle of the right side of the flexible electronic device 1 exceeds the preset angle, an instruction for controlling the data page displayed on the flexible display 20 to scroll to the left is acquired from the storage unit 30.

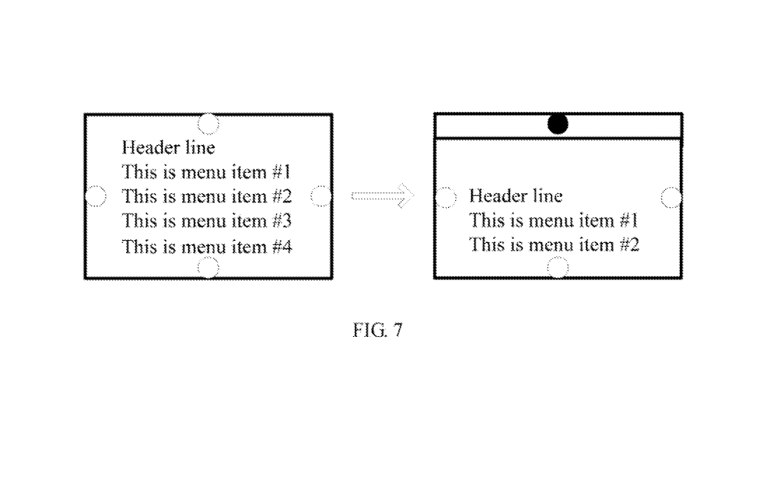

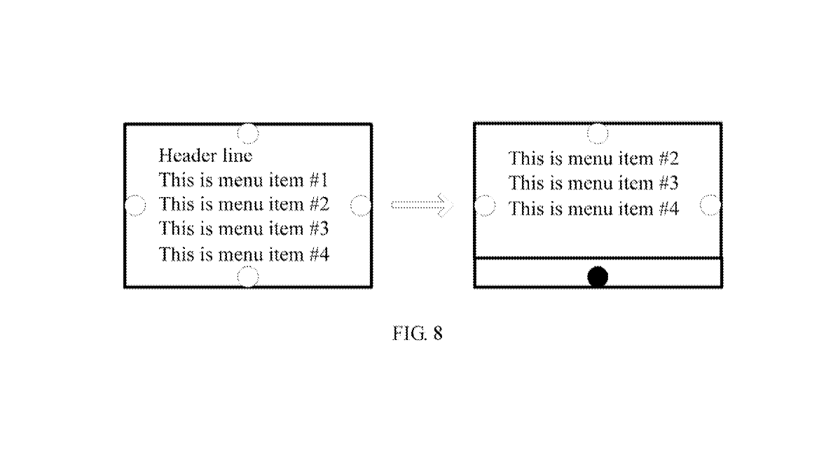

As shown in FIG. 7, if the upper side of the flexible electronic device 1 is bent upwards, and the curved angle of the upper side of the flexible electronic device 1 exceeds the preset angle, an instruction for controlling the data page displayed on the flexible display 20 to scroll down is acquired from the storage unit 30. As shown in FIG. 8, if the bottom side of the flexible electronic device 1 is bent upwards, and the curved angle of the bottom side of the flexible electronic device 1 exceeds the preset angle, an instruction for controlling the data page displayed on the flexible display 20 to scroll up is acquired from the storage unit 30.

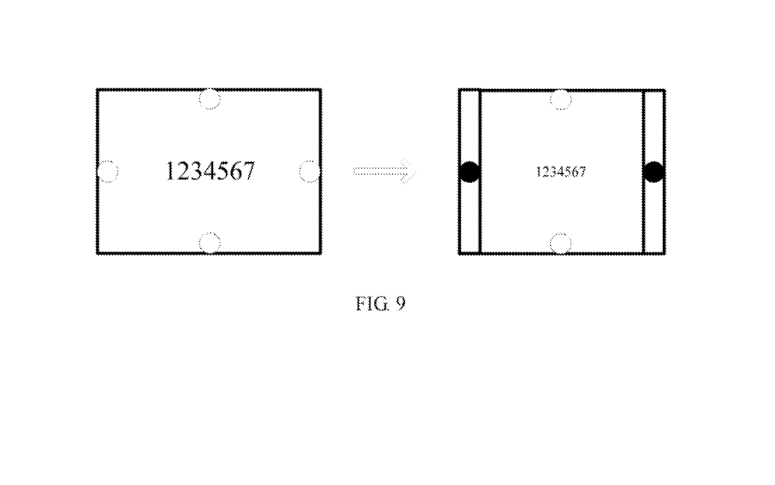

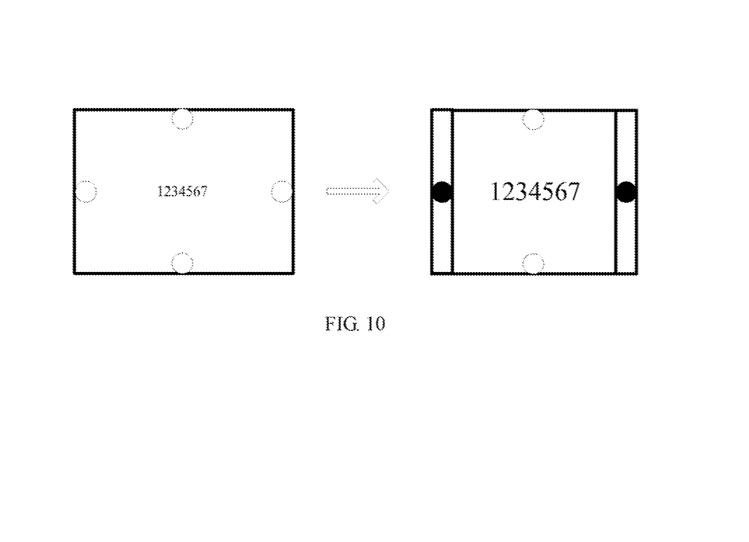

As shown in FIG. 9, if the left side and the right side of the flexible electronic device 1 are both bent upwards, and the curved angles of the left side and the right side of the flexible electronic device 1 both exceed the preset angle, an instruction for controlling the data page displayed on the flexible display 20 to zoom out is acquired from the storage unit 30. As shown in FIG. 10, if the left side and the right side of the flexible electronic device 1 are both bent downwards, and the curved angles of the left side and the right side of the flexible electronic device 1 both exceed the preset angle, an instruction for controlling the data page displayed on the flexible display 20 to zoom in is acquired from the storage unit 30.

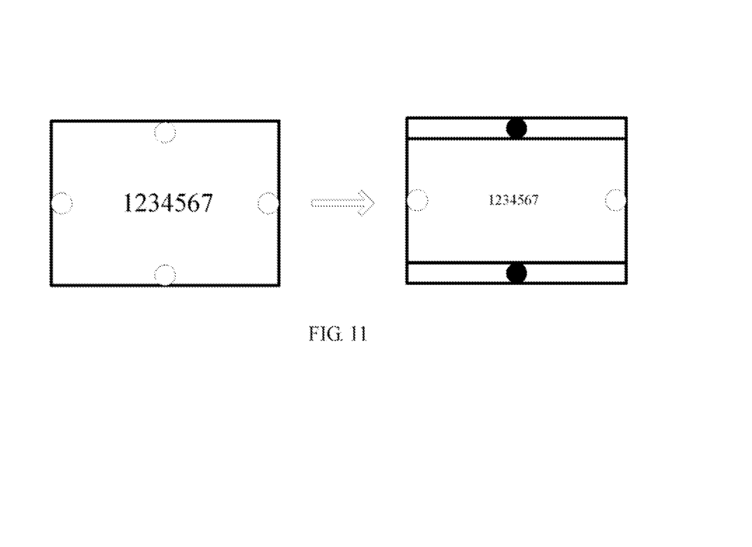

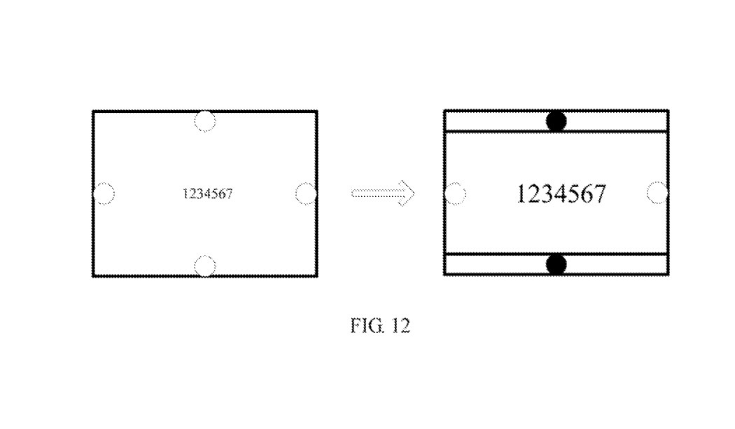

As shown in FIG. 11, if the upper side and the bottom side of the flexible electronic device 1 are both bent upwards, and the curved angles of the upper side and the bottom side of the flexible electronic device 1 both exceed the preset angle, the instruction for controlling the data page displayed on the flexible display 20 to zoom out is acquired from the storage unit 30. As shown in FIG. 12, if the upper side and the bottom side of the flexible electronic device 1 are both bent downwards, and the curved angles of the upper side and the bottom side of the flexible electronic device 1 both exceed the preset angle, the instruction for controlling the data page displayed on the flexible display 20 to zoom in is acquired from the storage unit 30.

In step S18, the execution module 600 executes the acquired instruction to control movement of the data page displayed on the flexible display 20. For example, as shown in FIG. 5, the execution module 600 executes the acquired instruction to control the data page displayed on the flexible display 20 to move to the right. As shown in FIG. 9, the execution module 600 executes the acquired instruction to control the data page displayed on the flexible display 20 to zoom out. As shown in FIG. 12, the execution module 600 executes the acquired instruction to control the data page displayed on the flexible display 20 to zoom in. In one embodiment, a speed of moving, zooming in, and zooming out the data page is proportional to the curved angle.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a flexible electronic device, the flexible electronic device comprising a flexible display and a plurality of gravity sensors, the method comprising:
(a) setting a preset position of each side of the flexible electronic device, a preset angle of bending a side of the flexible electronic device, a plurality of operations on the flexible electronic device for controlling a data page displayed on the flexible display, instructions associated with the operations, and effective curved directions of each side of the flexible electronic device;
(b) receiving current position data of each side of the flexible electronic device from corresponding gravity sensors, wherein the gravity sensors are positioned at each side of the flexible electronic device;
(c) calculating a curved angle and a curved direction of each side of the flexible electronic device according to the current position data and the preset position, and determining whether any curved angle of the effective curved direction of corresponding side of the flexible electronic device exceeds the preset angle;
(d) determining an operation according to the curved angle and the curved direction of each side of the flexible electronic device, and acquiring an instruction associated with the operation from a storage unit, in response to determining that the curved angle of the effective curved direction of any side of the flexible electronic device exceeds the preset angle; and
(e) executing the acquired instruction to control movement of the data page displayed on the flexible display.

2. The method as claimed in claim 1, wherein the preset position is set according to an XYZ coordinate system, and the preset position of the flexible electronic device is in the XY plane, such that the Z-axis is perpendicular to a front surface of the flexible electronic device.

3. The method as claimed in claim 1, wherein the curved angle is an angle between the preset position of a side of the flexible electronic device and the current position of the side of the flexible electronic device.

4. The method as claimed in claim 1, wherein the curved direction is a direction from the preset position of the side of the flexible electronic device to the current position of the side of the flexible electronic device.

5. The method as claimed in claim 1, wherein the instructions comprise moving, zooming in, and zooming out the data page.

6. A non-transitory storage medium storing a set of instructions, the set of instructions being executed by a processor of a flexible electronic device comprising a flexible display and a plurality of gravity sensors, to perform a method comprising:
(a) setting a preset position of each side of the flexible electronic device, a preset angle of bending a side of the flexible electronic device, a plurality of operations on the flexible electronic device for controlling a data page displayed on the flexible display, instructions associated with the operations, and effective curved directions of each side of the flexible electronic device;
(b) receiving current position data of each side of the flexible electronic device from corresponding gravity sensors, wherein the gravity sensors are positioned at each side of the flexible electronic device;
(c) calculating a curved angle and a curved direction of each side of the flexible electronic device according to the current position data and the preset position, and determining whether any curved angle of the effective curved direction of corresponding side of the flexible electronic device exceeds the preset angle;
(d) determining an operation according to the curved angle and the curved direction of each side of the flexible electronic device, and acquiring an instruction associated with the operation from a storage unit, in response to determining that the curved angle of the effective curved direction of any side of the flexible electronic device exceeds the preset angle; and
(e) executing the acquired instruction to control movement of the data page displayed on the flexible display.

7. The non-transitory storage medium as claimed in claim 6, wherein the preset position is set according to an XYZ coordinate system, and the preset position of the flexible electronic device is in the XY plane, such that the Z-axis is perpendicular to a front surface of the flexible electronic device.

8. The non-transitory storage medium as claimed in claim 6, wherein the curved angle is an angle between the preset position of a side of the flexible electronic device and the current position of the side of the flexible electronic device.

9. The non-transitory storage medium as claimed in claim 6, wherein the curved direction is a direction from the preset position of the side of the flexible electronic device to the current position of the side of the flexible electronic device.

10. The non-transitory storage medium as claimed in claim 6, wherein the instructions comprise moving, zooming in, and zooming out the data page.

11. A flexible electronic device, the flexible electronic device comprising:
a flexible display;
a plurality of gravity sensors located at each side of the flexible electronic device;
at least one processor; and
a storage unit storing one or more programs, which when executed by the at least one processor, causes the at least one processor to:
set a preset position of each side of the flexible electronic device, a preset angle of bending a side of the flexible electronic device, a plurality of operations on the flexible electronic device for controlling a data page displayed on the flexible display, instructions associated with the operations, and effective curved directions of each side of the flexible electronic device;
receive current position data of each side of the flexible electronic device from corresponding gravity sensors;
calculate a curved angle and a curved direction of each side of the flexible electronic device according to the current position data and the preset position, and determine whether any curved angle of the effective curved direction of corresponding side of the flexible electronic device exceeds the preset angle;
determine an operation according to the curved angle and the curved direction of each side of the flexible electronic device, and acquiring an instruction associated with the operation from the storage unit, in response to determining that the curved angle of the effective curved direction of any side of the flexible electronic device exceeds the preset angle; and
execute the acquired instruction to control movement of the data page displayed on the flexible display.

12. The flexible electronic device as claimed in claim 11, wherein the preset position is set according to an XYZ coordinate system, and the preset position of the flexible electronic device is in the XY plane, such that the Z-axis is perpendicular to a front surface of the flexible electronic device.

13. The flexible electronic device as claimed in claim 11, wherein the curved angle is an angle between the preset position of a side of the flexible electronic device and the current position of the side of the flexible electronic device.

14. The flexible electronic device as claimed in claim 11, wherein the curved direction is a direction from the preset position of the side of the flexible electronic device to the current position of the side of the flexible electronic device.

15. The flexible electronic device as claimed in claim 11, wherein the instructions comprise moving, zooming in, and zooming out the data page.
